(19) United States
(12) Patent Application Publication
(10) Pub. No.: US 2003/0194937 A1
(43) Pub. Date: Oct. 16, 2003

(54) Composite abrasive articles and a method for making same

(76) Inventors: Yarron Bendor, Scottsdale, AZ (US); Ilan Pickman, Kibbutz Shamir of Upper Galilee (IL); Rachel Ben Horin, Kibbutz Shamir of Upper Galilee (IL); Gil Strauss, Kibbutz Shamir of Upper Galilee (IL)

Correspondence Address: JENKINS & WILSON, PA, 3100 TOWER BLVD, SUITE 1400, DURHAM, NC, 27707, US

(21) Appl. No.: 10/120,050

(22) Filed: Apr. 10, 2002

(51) Int. Cl. B32B 5/26; D04H 1/00; D04H 3/00

(52) U.S. Cl. 442/334; 442/381; 442/268; 442/414; 442/340; 442/409

(57) ABSTRACT

A composite abrasive nonwoven web is prepared by passing fibers through a card to yield a pre-bond web following by the bonding of the pre-web in a calender to achieve a composite abrasive nonwoven web. The composite abrasive nonwoven web may be manufactured in, for example, one or two stages. The produced composite web may have at least two layers where, for example, one layer is an absorbent smooth layer and another layer is a rough abrasive layer.

composite nonwoven webs. The composite webs include four layers which are meltblown or spunbouded webs.

### DISCLOSURE OF THE INVENTION

The present invention seeks to provide an improved composite abrasive article and the method for making same.

There is thus provided in accordance with an embodiment of the invention a composite abrasive nonwoven web comprising a carrier web and an abrasive web comprising thick fibers.

There is thus provided in accordance with an embodiment of the invention a composite abrasive nonwoven web comprising a blend of thin fibers, absorbent fibers and thick fibers.

There is thus provided in accordance with an embodiment of the invention a method for producing a composite abrasive nonwoven web, the method comprising the steps of providing a carrier web, feeding thick fibers into a card, passing the thick fibers through the card to produce a pre-bonded thick fiber web and thermobonding the pre-bonded thick fiber web and the carrier web.

Further in accordance with an embodiment of the invention the step of providing a carrier web comprising feeding thin fibers and absorbent fibers into a card, passing the thin fibers and absorbent fibers through the card to produce a pre-bonded thin fiber web and bonding the pre-bonded thin fiber web into a carrier web.

Further in accordance with an embodiment of the invention the step of providing a carrier web by feeding thin fibers and absorbent fibers into a first card and passing the thin fibers and absorbent fibers through the first card to produce a pre-bonded thin fiber web and wherein the step of feeding the thick fibers into a card uses a second card and the pre-bonded thick fiber web is produced on top of the pre-bonded thin fiber web to produce a composite pre-bonded fiber web.

There is thus provided in accordance with an embodiment of the invention a method for producing a composite abrasive nonwoven web comprising the steps of feeding a blend of thin fibers, absorbent fibers and thick fibers into a card, passing the blend through the card to produce a pre-bonded composite web and bonding the pre-bonded composite web into a composite abrasive nonwoven web.

Some of the objects of the invention having been stated hereinabove, other objects will become evident as the description proceeds when taken in connection with the accompanying drawings as best described hereinbelow.

### BRIEF DESCRIPTION OF THE DRAWINGS

The invention will be understood and appreciated more fully from the following detailed description taken in conjunction with the drawings in which:

FIG. 1 is a schematic illustration of the produced layered composite abrasive nonwoven web according to an embodiment of the invention;

FIG. 2 is a schematic illustration of the produced composite abrasive nonwoven web according to another embodiment of the invention;

FIGS. 3A-3B are a schematic illustration of a process for producing a layered composite abrasive nonwoven web in accordance with an embodiment of the invention;

FIG. 4 is a schematic illustration of a process for producing a layered composite abrasive nonwoven web in accordance with another embodiment of the invention;

FIG. 5 is a schematic illustration of a process for producing a composite abrasive nonwoven web in accordance with a further embodiment of the invention; and

FIG. 6 is a flow chart depicting a series of steps according to an embodiment of the invention.

### DETAILED DESCRIPTION OF THE INVENTION

In the following description, various aspects of the present invention will be described. For purposes of explanation, specific configurations and details are set forth in order to provide a thorough understanding of the invention.

However, it will also be apparent to one skilled in the art that the invention may be practiced without the specific details presented herein. Furthermore, well-known features may be omitted or simplified in order not to obscure the invention.

The composite abrasive nonwoven web in an embodiment of the invention is prepared by a carded thermobond technology, in one or more stages.

Embodiments of the invention relate to composite abrasive nonwoven webs which have an absorbent, smooth side and a rougher, abrasive side.

Reference is now made to FIG. 1, which is a schematic illustration of the layered composite abrasive nonwoven web W according to an embodiment of the invention. The layered composite abrasive nonwoven web W includes, for example, a carrier web 32 and an abrasive web 34. Carrier web 32 typically includes thin fibers and absorbent fibers. “Thin fibers” are defined herein as synthetic staple fibers having a thickness of less than 5 dtex. “Absorbent fibers” are defined herein as fiber that absorb liquid including synthetic staple absorbent fibers having thickness of less than 5 dtex and natural absorbent fibers. Hereinafter the thickness of absorbent fibers means the thickness of the synthetic staple absorbent fibers. The synthetic absorbent fibers may include for example, viscose, lyocel, acetate, etc. The natural absorbent fibers may include, for example, cotton, fluff pulp etc. The thin fibers may include, for example, polypropylene, polyamide, polyester, polyethylene and bi-component polymer fibers for high tensile strength. In one embodiment the carrier web includes 60-100% thin fiber and 0-40% absorbent fibers. The thin fibers are typically polypropylene fibers with a thickness in the range of 1-3.3 dtex. The absorbent fibers have a thickness typically in the range of 1.2-3.3 dtex. The weight of the carrier web 32 is in the range of about 20 to about 80 grams per square meter. In an alternate embodiment carrier web 32 may be a woven or a nonwoven web and may include more than one layer.

Abrasive web 34 includes an abrasive rough layer of thick fibers. “Thick fibers” are defined as synthetic staple fibers having average thickness (measured in dtex) which is at least 30% higher than the average thickness of the thin fibers. The thick fibers may include, for example, polypropylene, polyamide, polyester, polyethylene and bi-component polymer fibers for high tensile strength. The thick fibers are typically polypropylene fibers. In one embodiment abrasive web layer 34 include 20-100% thick fibers having a thickness of typically 13 dtex or higher and 0-20% thick fibers having a thickness lower than 13 dtex. In another embodiment, abrasive web layer 34 includes 100% polypropylene fibers having a thickness higher than 13 dtex. In a further embodiment, abrasive web layer includes 50% polypropylene fibers having a thickness of about 13 dtex and 50% polypropylene fibers having a thickness of 20 dtex or higher. In another embodiment abrasive web layer 34 includes fibers having thickness of 30% higher than the average thickness of the thin fibers. The weight of the abrasive web 34 is typically in the range of about 7 to about 40 grams per square meter.

The weight of the composite abrasive nonwoven web W comprising the carrier web 32 and the abrasive web 34 is typically in the range of 30-120 grams per square meter. The length of the synthetic staple fibers is typically in the range of 25-90 mm. Other thicknesses of fibers may be used, and the weight of the produced webs may be different.

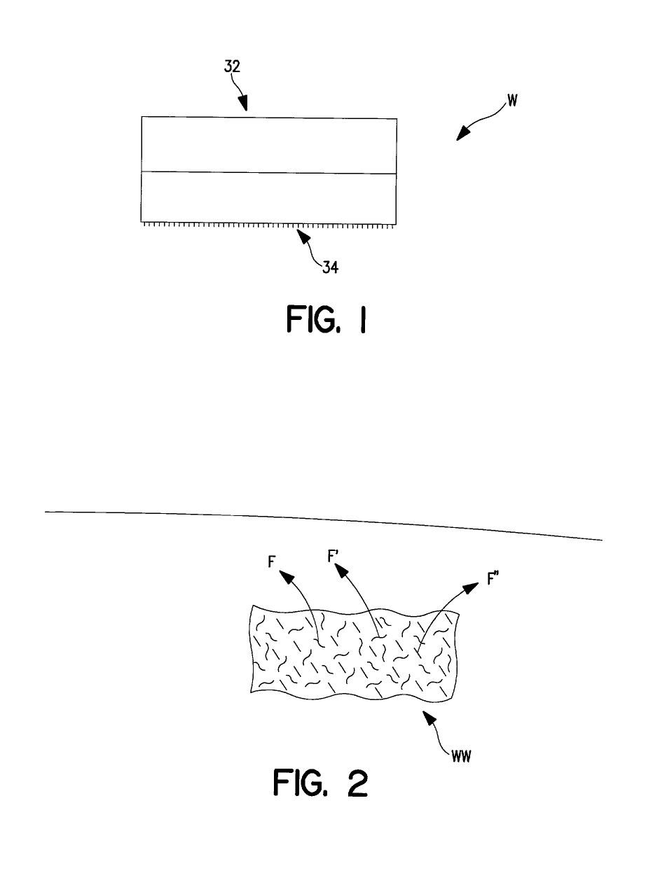

Reference is now made to FIG. 2 which is a schematic illustration of a one layer composite abrasive nonwoven web WW according to an embodiment of the invention. The one-layer composite abrasive nonwoven web WW is made of a blend of thin F, absorbent F′ and thick F″ fibers. The composite abrasive nonwoven web WW typically include 0-40% absorbent fibers, 20-50% thin fibers and 30-70% thick fibers. The thin and thick fibers are typically polypropylene fibers. The thickness of the thin fibers is typically in the range of 1.2-3.3 dtex. In one embodiment the thickness of the absorbent fibers is 1.7 dtex and the thickness of the thin polypropylene fibers is typically in the range of 1-3.3 dtex. In another embodiment, the thick fibers include 30-70% polypropylene fibers having a thickness of 13 dtex or higher.

In another embodiment composite abrasive nonwoven web WW includes 25% thin fibers, for example, polypropylene fibers having a thickness in the range of 1-3.3 dtex, 25% absorbent fibers, and 50% thick polypropylene fibers having a thickness of 13 dtex or higher. The length of the fibers is typically in the range of 25-90 mm.

Other thicknesses or lengths of fibers may be used, and the weight of the produced webs may be different.

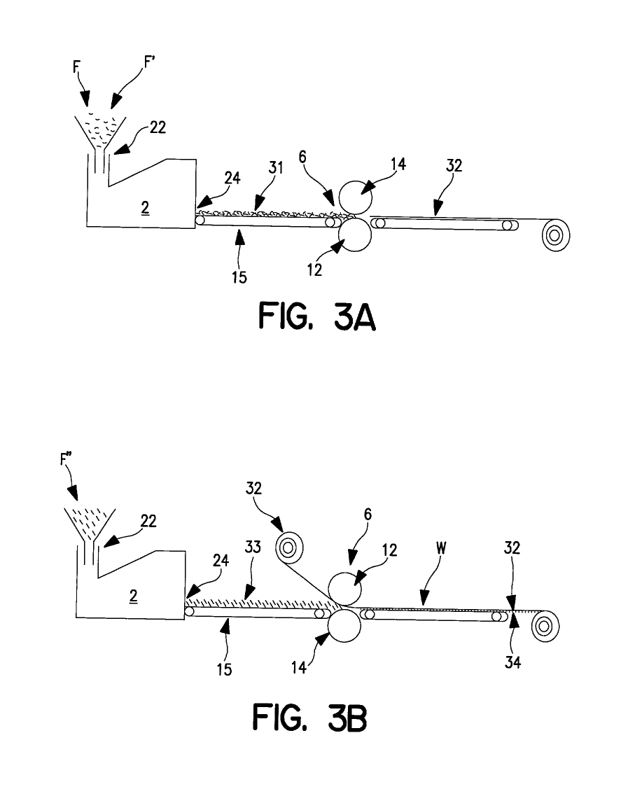

Reference is now made to FIGS. 3A-3B illustrating a process for producing a layered composite abrasive nonwoven web W according to an embodiment of the invention. According to one embodiment, the production process comprised of two main stages. FIG. 3A illustrates the first stage of the production process where a carrier web 32 is produced. Thin fibers F and absorbent fibers F′ are fed into a card 2 through inlet 22. Thin fibers F and absorbent fibers F′ are passed through card 2 wherein they are manufactured into a pre-bonded thin fiber web 31. The pre-bonded thin fiber web 31 exits the card through outlet 24 and is transferred, for example on a conveyor 15, to a calender 6 that bonds the pre-bonded thin fiber web 31 into a carrier web 32. In alternate embodiment, card 2 has two outlets (not shown).

The bonding of the pre-bonded thin fiber web 31 into a carrier web 32 may be by thermobonding, for example, by air through or by a calender. Calender 6 typically includes two heated metal rollers: a smooth roller 12 and an embossed roller 14. In one embodiment, smooth roller 12 is the upper roller and embossed roller 14 is the lower roller. In another embodiment, embossed roller 14 is the upper roller and smooth roller 12 is the lower roller. The pre-bonded thin fiber web 31 is typically passed between the two rollers 12 and 14 of calender 6. Both rollers typically have a temperature in the range of 100-180° C. Alternately, the rollers may have other temperature ranges. Calender 6 bonds the pre-bonded thin fiber web 31 into a carrier web 32 by pressure and heat. Carrier web 32 may then, for example, be wound on a winder.

In an alternate embodiment (not shown), the bonding may be achieved by chemical or mechanical methods. The thermobonding may be achieved by air bonding or any other method of thermobonding.

The fibers fed into card 2, typically include 0-40% absorbent fibers for improved absorbency and 60-100% thin fibers. In one embodiment, the thickness of the absorbent fibers is in the range of 1-3.3 dtex. In another embodiment, the thickness of the absorbent fibers is typically 1.7 dtex and the thickness of the thin fibers, which are, for example, polypropylene is typically in the range of 1-3.3 dtex. The weight of the produced carrier web 32 is typically in the range of about 20 to about 80 grams per square meter. Other thicknesses of fibers may be used, the roller temperature may be different and the weight of the produced webs may be different.

In an alternate embodiment, carrier web 32 may be manufactured by other processes such as spunbonding, meltblowing, spunlace, etc. and may include more than one layer.

FIG. 3B illustrates the second stage of the production process according to an embodiment of the invention, where a pre-bonded thick fiber web 33 is produced. Thick fibers F″ are fed into card 2 through inlet 22. Thick fibers F″ are passed through card 2 wherein they are manufactured into a pre-bonded thick fiber web 33. The pre-bonded thick fiber web 33 exits the card 2 through outlet 24 to conveyor 15. Carrier web 32 is typically unwound and placed on top of the pre-bonded thick fiber web 33 on conveyor 15. Pre-bonded thick fiber web 33 and carrier web 32 are typically passed between the two rollers 12 and 14 of calender 6 simultaneously. Calender 6 bonds the pre-bonded thick fiber web 33 and the carrier web 32 into a layered composite abrasive nonwoven web W by pressure and heat. The produced two-layer composite abrasive nonwoven web W may, for example, be cut into the desired width and wound on a winder. In one embodiment, smooth roller 12 of calender 6 is the upper roller and embossed roller 14 of calender 6 is the lower roller. In this case, roller 14, which is in contact with the pre-bonded thick fiber web 33, has a temperature typically in the range of 130-200° C. and roller 12, which is in contact with the carrier web 32, has a temperature typically in the range of 80-150° C. In one embodiment, thick fibers F″, which are fed into card 2 through inlet 22 having average thickness which is at least 30% higher than the average thickness of the carrier web fibers. In another embodiment, thick fibers F″, which are fed into card 2, include 20-100% polypropylene fibers having a thickness higher than 13 dtex, and 0-20% polypropylene fibers having a thickness lower than 13 dtex. In another embodiment, thick fibers F″ include 100% polypropylene fibers having a thickness of 13 dtex or higher. In a further embodiment, thick fibers F″ include 50% polypropylene fibers having a thickness of about 13 dtex and 50% polypropylene fibers having a thickness of 20 dtex or higher. The weight of the produced abrasive web 34 is in the range of about 7 to about 40 grams per square meter and preferably 10-20 grams per square meter. Other thicknesses of fibers may be used, the roller temperature may be different, and the weight of the produced webs may be different.

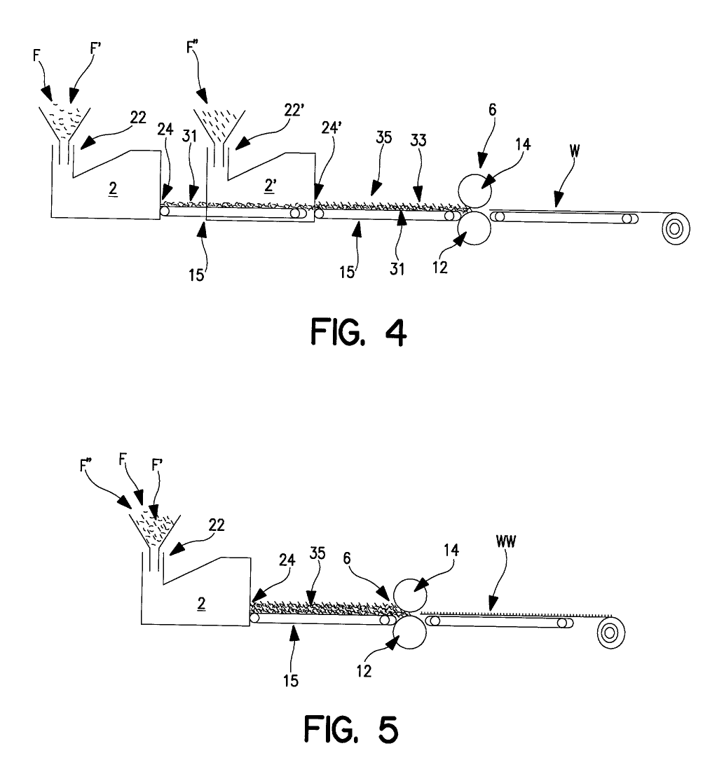

Reference is now made to FIG. 4, illustrating the process for producing a layered composite abrasive nonwoven web W in accordance with another embodiment of the present invention. According to one embodiment, the production process is a one-stage process. Thin fibers F and absorbent fibers F′ are fed into a card 2 through inlet 22, and passed through card 2 wherein they are manufactured into pre-bonded thin fiber web 31. The pre-bonded thin fiber web 31 exits the card through outlet 24 and is transferred, for example, on a conveyor 15 below a second card 2′. Thick fibers F″ are fed into a card 2′ through inlet 22′ and passed through card 2′ wherein they are manufactured into a pre-bonded thick fiber web 33. In one embodiment thick fibers 9 include 20-100% polypropylene fibers having a thickness higher than 13 dtex, and 0-20% polypropylene fibers having a thickness lower than 13 dtex. Pre-bonded thick fiber web 33 exits card 2′ through outlet 24′ and is placed on the conveyor 15 on top of the first pre-bonded thin fiber web 31, yielding a two-layer composite pre-bonded fiber web 35. The two-layer composite pre-bonded fiber web 35 is transferred, for example, on the conveyor 15, to calender 6, wherein the two-layer pre-bonded fiber is bonded into a two-layer composite abrasive nonwoven web W by pressure and heat. In one embodiment, embossed roller 14 is the upper roller and, thus, is in contact with the pre-bonded thick fiber web 33, smooth roller 12 is the lower roller, and thus in contact with the pre-bonded thin fiber web 31. In an alternate embodiment, smooth roller 12 is the upper roller, and thus in contact with the pre-bonded thick fiber web 33, and embossed roller 14 is the lower roller, and thus in contact with the pre-bonded thin fiber web 31. Roller 12 has a temperature typically in the range of 80-150° C. and roller 14 has a temperature typically in the range of 120-200° C. The produced two-layer composite abrasive nonwoven web W may, for example, be cut into the desired width and wound on a winder. Other thicknesses of fibers may be used, the roller temperature may be different, and the weight of the produced webs may be different.

Reference is now made to FIG. 5, illustrating the process for producing a one-layer composite abrasive nonwoven web WW in accordance with another embodiment of the invention. According to one embodiment, the production process is a one-stage process. A blend of thin fibers F, absorbent fibers F′ and thick fibers F″ is fed into a card 2 through inlet 22, and passed through card 2 where it is manufactured into pre-bonded composite fiber web 35. In one embodiment the blend include 0-40% absorbent fiber, 20-50% thin fiber and 30-70% thick fibers. In one embodiment the thick fiber having dtex of 13 dtex or higher. The pre-bonded composite fiber web 35 exits the card through outlet 24 and is transferred, for example, on a conveyor 15, to calender 6 where the pre-bonded composite fiber web 35 is bonded into one-layer composite abrasive nonwoven web WW by pressure and heat. In one embodiment, smooth roller 12 is the upper roller and embossed roller 14 is the lower roller. In another embodiment, embossed roller 14 is the upper roller and smooth roller 12 is the lower roller. Both smooth roller 12 and embossed roller 14 have a temperature which is typically in the range of 120-180°C. Other temperatures of rollers may be applied. The produced one-layer composite abrasive nonwoven web WW may, for example, be cut into the desired width and wound on a winder. Other thicknesses of fibers may be used, the roller temperature may be different, and the weight of the produced webs may be different.

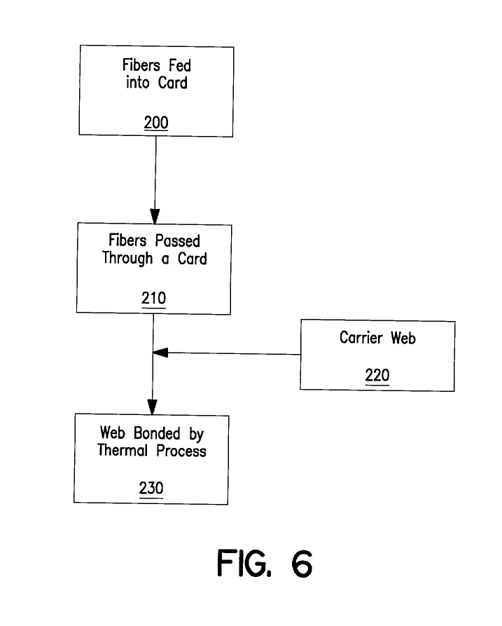

Reference is now made to FIG. 6 which is a flow chart depicting a series of steps according to an embodiment of the invention. In step 200 thick fibers are fed into a card. In step 210, the thick fibers are passed through the card to produce a pre-bonded web. In step 220, the carrier web is introduced. In various embodiments the carrier web may be produced as depicted in step 200 and 210 by feeding thin fibers into a card. In step 230 thick fiber web and carrier web are bonded into a composite abrasive web. In alternate embodiments, a different series of steps may be used.

It should be appreciated that the preferred embodiments described hereinabove are described by way of example only and that numerous modifications thereto, all of which fall within the scope of the present invention, exist.

For example, while the present invention is described with respect to a composite nonwoven web having two layers and a method for producing such web, the composite nonwoven web may have more than two layers. For example, an absorbent layer having high percentage of thin adsorbent fibers (e.g., more than 40%) may be added between the carrier web layer and the abrasive layer. A composite web having more than two layers may be produced similarly as was described hereinabove and illustrated in FIGS. 3A-3B by repeating the stage illustrated in FIG. 3B. A two-layered composite web comprising the carrier web layer and the additional absorbed layer may be manufactured according to one of the described embodiments. A pre-bonded thick fiber web may be manufactured according to the procedure illustrated in FIG. 3B. The pre-bonded thick fiber web exits the card, for example, on conveyor 15, to calender 6 and passes between the two rollers of the calender simultaneously with the two-layered composite web to obtain a three-layered composite web.

It will be understood that various details of the invention may be changed without departing from the scope of the invention. Furthermore, the foregoing description is for the purpose of illustration only, and not for the purpose of limitation—the invention being defined by the claims.

What is claimed is:

1. A composite abrasive nonwoven web comprising:
a. a carrier web; and
b. an abrasive web comprising thick fibers;
wherein at least one of the carrier web and the abrasive web are formed by a card.

2. The composite abrasive nonwoven web of claim 1 wherein said carrier web comprises a woven web.

3. The composite abrasive nonwoven web of claim 1 wherein said carrier web comprises a nonwoven web.

4. The composite abrasive nonwoven web of claim 1 wherein said carrier web comprises at least two layers.

5. The composite abrasive nonwoven web of claim 1 wherein said carrier web comprises 0-40% absorbent fibers.

6. The composite abrasive nonwoven web of claim 1 wherein said carrier web comprises absorbent fibers in the range of 1.2-3.3 dtex.

7. The composite abrasive nonwoven web of claim 1 wherein said carrier web comprises 60-100% of thin fibers.

8. The composite abrasive nonwoven web of claim 7 wherein said thin fibers comprise polypropylene fiber having a thickness of 1-3.3 dtex.

9. The composite abrasive nonwoven web of claim 1 wherein said thick fibers have a fiber length in the range of 25-90 mm.

10. The composite abrasive nonwoven web of claim 1 wherein said thick fibers comprise polypropylene fibers.

11. The composite abrasive nonwoven web of claim 1 wherein said carrier web comprises thin fibers and absorbent fibers.

12. The composite abrasive nonwoven web of claim 1 wherein 0-20% of said thick fibers have a thickness lower than 13 dtex.

13. The composite abrasive nonwoven web of claim 12 wherein 20-100% of said thick fibers have a thickness of 13 dtex or higher.

14. A composite abrasive nonwoven web comprising a blend of thin fibers, absorbent fibers and thick fibers.

15. The composite abrasive nonwoven web of claim 14 wherein said web comprises 0-40% absorbent fibers and 60-100% thin and thick fibers.

16. The composite abrasive nonwoven web of claim 15 wherein said 60-100% thin and thick fibers comprises 20-50% thin fibers and 30-70% thick fibers.

17. The composite abrasive nonwoven web of claim 14 wherein said absorbent fibers have a thickness in the range of 1.2-3.3 dtex.

18. The composite abrasive nonwoven web of claim 14 wherein said thin and thick fibers have a fiber length in the range of 25-90 mm.

19. The composite abrasive nonwoven web of claim 14 wherein the thin and thick fibers comprise polypropylene fibers.

20. The composite abrasive nonwoven web of claim 14 wherein at least 50% of said thick fibers have a thickness lower than 13 dtex.

21. The composite abrasive nonwoven web of claim 14 wherein at least 50% of said thick fibers have a thickness of 13 dtex or higher.

22. A method for producing a composite abrasive nonwoven web, the method comprising the steps of:
a. providing a carrier web;
b. feeding thick fibers into a card;
c. passing said thick fibers through said card to produce a pre-bonded thick fiber web; and
d. thermobonding said pre-bonded thick fiber web and said carrier web.

23. The method of claim 22 wherein said thermobonding step includes at least air bonding.

24. The method of claim 22 wherein said thermobonding step includes at least the use of a calender.

25. The method of claim 24 wherein said calender comprises a smooth roller and an embossed roller.

26. The method of claim 25 wherein said smooth roller is heated to a temperature range of 40-180° C.

27. The method of claim 25 wherein said embossed roller is heated to a temperature range of 130-200° C.

28. The method of claim 22 wherein said step of providing a carrier web comprises the steps of:
a. feeding thin fibers and absorbent fibers into a card;
b. passing said thin fibers and absorbent fibers through said card to produce a pre-bonded thin fiber web; and
c. bonding said pre-bonded thin fiber web into a carrier web.

29. The method of claim 28 wherein said bonding step comprises mechanical bonding.

30. The method of claim 28 wherein said bonding step comprises chemical bonding.

31. The method of claim 28 wherein said bonding step comprises thermobonding.

32. The method of claim 31 wherein said thermobonding step includes at least air bonding.

33. The method of claim 31 wherein said thermobonding step includes at least the use of a calender.

34. The method of claim 33 wherein said calender comprises a smooth roller and an embossed roller heated to a temperature range of 120-200° C.

35. The method of claim 22 wherein said step of providing a carrier web comprises the steps of:
a. feeding thin fibers and absorbent fibers into a first card; and
b. passing said thin fibers and absorbent fibers through said first card to produce a pre-bonded thin fiber web;
c. wherein the step of feeding said thick fibers into a card uses a second card; and said pre-bonded thick fiber web is produced on top of said pre-bonded thin fiber web to produce a composite pre-bonded fiber web;
d. thermobonding said composite pre-bonded fiber web into a composite abrasive nonwoven web.

36. The method of claim 35 wherein said thermobonding step includes at least air bonding.

37. The method of claim 35 wherein said thermobonding step includes at least the use of a calender.

38. The method of claim 37 wherein said calender comprises a smooth roller and an embossed roller.

39. The method of claim 38 wherein said smooth roller is heated to a temperature range of 40-180° C.

40. The method of claim 38 wherein said embossed roller is heated to a temperature range of 130-200° C.

41. A method for producing a composite abrasive nonwoven web, the method comprising the steps of:
a. feeding a blend of thin fibers, absorbent fibers and thick fibers into a card;
b. passing said blend through said card to produce a pre-bonded composite web; and
c. bonding said pre-bonded composite web into a composite abrasive nonwoven web.

42. The method of claim 41 wherein said bonding step comprises thermobonding.

43. The method of claim 42 wherein said thermobonding step includes at least air bonding.

44. The method of claim 42 wherein said thermobonding step includes at least the use of a calender.

45. The method of claim 44 wherein said calender comprises a smooth roller and an embossed roller heated to a temperature range of 100-180° C.

46. A method for producing a composite abrasive nonwoven web, the method comprising the steps of:
a. providing a carrier web;
b. feeding thick fibers into a card;
c. passing said thick fibers through said card to produce a pre-bonded thick fiber web; and
d. thermobonding said pre-bonded thick fiber web and said carrier web through a calender.

47. A method for producing a composite abrasive nonwoven web, the method comprising the steps of:
a. feeding a blend of thin fibers, thick fibers and absorbent fibers into a card;
b. passing said blend through said card to produce a pre-bonded composite web; and
c. thermobonding said pre-bonded composite web into a composite abrasive nonwoven web through a calender.

48. A method for producing a composite abrasive nonwoven web, the method comprising the steps of:
a. providing a carrier web;
b. feeding fibers having a thickness of 13 dtex or higher into a card;
c. passing said fibers through said card to produce a pre-bonded thick fiber web; and
d. bonding said pre-bonded thick fiber web and said carrier web.

49. A method for producing a composite abrasive nonwoven web, the method comprising the steps of:
a. feeding a blend of viscose fibers having a thickness lower than 5 dtex and thermoplastic polypropylene fibers having a thickness in a range of 1-20 dtex into a card;
b. passing said viscose fibers and said thermoplastic polypropylene fibers through said card to produce a pre-bonded composite web; and
c. bonding said pre-bonded composite web into a composite abrasive nonwoven web.
